(19) United States
(12) Patent Application Publication
(10) Pub. No.: US 2013/0093585 A1
(43) Pub. Date: Apr. 18, 2013

(54) MOTORCYCLE HELMET WITH ELECTRONIC SAFETY FEATURES

(71) Applicant: Amar Vimal AMBANI, Ahmedabad (IN)

(72) Inventor: Amar Vimal AMBANI, Ahmedabad (IN)

(21) Appl. No.: 13/274,908

(22) Filed: Oct. 17, 2011

(51) Int. Cl. B60Q 1/34

(52) U.S. Cl. 340/475

(57) ABSTRACT

A system for enhancing the safety and functionality of a motorcycle or bicycle type helmet includes built-in turn and brake indicators, a transceiver for wireless communications with a corresponding transceiver mounted on a motorcycle, bicycle, or other vehicle, and a speaker and a microphone. The speaker and microphone permits two-way audio communications between the wearer of the helmet and others, either through a cellular network or through a wireless connection to the helmet of a passenger of the vehicle, and further permits such enhanced features as transmission of voice instructions to a navigation system and reception/playback of responsive navigation information, playback from a music system, and audio feedback that the turn signals are being operated, as well as anti-theft protection.

### BACKGROUND OF THE INVENTION

1. Field of the Invention

This invention relates to a motorcycle or bicycle helmet with enhanced safety features, including:
a. built-in brake and turn signals;
b. positive audible feedback for the turn signals;
c. two-way communications between driver and passenger;
d. hands-free cellular communications;
e. vehicle anti-theft protection (by providing a visual indication of a possibly stolen vehicle);
f. audio connection to entertainment/navigation devices or systems, for example to provide in-helmet verbal navigation capabilities; and
g. a secure method of securing the helmet to a vehicle when parked.

The addition of brake and turn signals to a motorcycle or bicycle helmet is known from, for example, U.S. Pat. No. 7,948,367 and U.S. Patent Publication No. 2009/0140847. However, the brake/turn signal units disclosed in these publications have limited functionality because they are self-contained units that are intended to be retrofitted onto existing helmets, and therefor address only one of the safety issues facing motorcyclists, namely the problem of signal visibility. The present invention, in contrast, provides enhanced functionality and safety by modifying the helmet itself to include not only an integrated indicator unit, but also a speaker and microphone so as to enable hands free communications with a passenger and/or cell phone communications, verbal turn-by-turn navigation capabilities, anti-theft features, and other safety enhancements.

2. Description of Related Art

In 2005, motorcycle fatalities accounted for more than 10% of all motor vehicle traffic crash fatalities, increasing by more than 110% over the previous ten years despite an increase of only 8.6% in vehicle miles of travel (VMT) for motorcycles. Much of this increase in fatality rates could be attributed to inadequate reaction time by other motorists. As a result, it was proposed in U.S. Pat. No. 7,948,367 (the '367 patent) to attach brake and turn indicators to a motorcycle helmet, where they could be better seen by other motorists. By increasing visibility of the brake and turn signals, the helmet-mounted indictors enable motorists to react sooner to braking and turning actions by the wearer of the helmet, increasing safety.

The basic approach taken by the '367 patent is to affix an integrated indicator/transceiver unit to the helmet, enabling retrofit of the unit onto an existing, unmodified helmet. As disclosed in the '367 patent, the transceiver is wirelessly connected to a transceiver unit mounted to the motorcycle and connected to the electrical system of the motorcycle so as to receive electrical signals whenever the brakes or turn signals of the motorcycle have been activated, and thereby activate the helmet-mounted brake and turn signals.

A similar helmet-mounted turn signal indicator device, suitable for use with a bicycle as well as a motorcycle, and which may include multiple display modes, is disclosed in U.S. Patent Publication No. 2009/0140847. Again, this patent takes the approach of fixing the indicator/transceiver unit onto an existing helmet.

The present invention extends the concept of wireless turn-and-brake-signal related communications between a transceiver unit of a motorcycle or bicycle helmet, and a transceiver unit on a motorcycle or bicycle. In particular, the vehicle-to-helmet communications of the invention include not just brake and turn indicators but also additional digital signals such as audio signals. In addition, the present invention modifies the helmet itself by integrating the turn and brake indicators and transceiver into the helmet so that they cannot easily be removed, and by adding speakers and a microphone. As a result, the present invention provides for the transmission of cellular telephone, GPS navigation, helmet-to-helmet communications, turn signal audible feedback, and other digital signals between the transceivers on the helmet and the vehicle. The addition of the speaker and microphone could be implemented either as a retrofit or as original helmet equipment.

In addition to the above-described advantages of increased functionality and security, the present invention overcomes an additional safety problem that arises with previously-proposed retrofit-type signaling arrangements, such as the one disclosed in the '367 patent. The problem is that the prior signaling arrangements can easily fall off during an accident, or even during normal use. For example, the elastic strap disclosed in the '367 patent may become loose during operation of the vehicle at high speed, and either break away or wear out due to the constant stretching. If any part falls off during vehicle operation, it can be a hazard to following vehicles.

The inclusion of enhanced safety features is especially important in developing country markets. In western markets, a motorbike is perceived to be a recreation vehicle and is often a second vehicle. In developing markets like China, India, Brazil, etc., two wheelers (motorcycles, scooters, mopeds etc) are many times the first and only vehicle in the family and are used as vehicles for daily commute. Thus, these additional safety and security features are a necessity rather than a cosmetic choice of accessory.

By way of additional background, helmet warning devices, some of which are retrofits and some of which appear to require helmet modification, are also disclosed in the following patents and publications: U.S. Patent Publication No. 2007/0285221 and U.S. Pat. Nos. 6,914,520; 6,406,168; 5,910,764; 5,704,707; 5,040,099; and 4,956,752. None of the prior patents and publications discloses a combination of helmet warning devices, speakers, and a microphone to provide an integrated safety/communication system of the type provided by the present invention.

It will be appreciated that the term “motorcycle helmet” encompasses helmets used on a variety of vehicles where the rider requires protective headgear, including motor scooters and mopeds, all-terrain vehicles, dune buggies, and three-wheeled motorized vehicles, in addition to motorcycles and bicycles.

### SUMMARY OF THE INVENTION

It is accordingly a first objective of the invention to provide enhanced safety for users of vehicles that require protective headgear, including by way of example and not limitation, motorcycles, bicycles, scooters, and mopeds.

It is a second objective of the invention to provide a vehicle-operator's helmet having enhanced safety features.

It is a third objective of the invention to provide a hands-free communication system for motorcycles, bicycles, and similar vehicles.

It is a fourth objective of the invention to provide a system for enabling safe usage of a cell phone, and/or communications with another rider, by operators of motorcycles, bicycles, and similar vehicles

It is a fifth objective of the invention to provide an improved navigation system for motorcycles, bicycles, and similar vehicles.

It is a sixth objective of the invention to provide a visual indication of a possibly stolen motorcycle, bicycle, or similar vehicle.

It is a seventh objective of the invention to provide an entertainment system suitable for use by operators of motorcycles, bicycles, and similar vehicles.

It is an eighth objective of the invention to provide a digitally secure method of securing a helmet to a motorcycle, bicycle, or similar vehicle when parked.

These objectives are accomplished, in accordance with the principles of preferred embodiments of the invention, by providing a motorcycle or bicycle helmet signaling/indicator system that includes a transceiver for wireless communications with a corresponding transceiver mounted on a motorcycle, bicycle, or other vehicle, and that is connected not only to brake and turn signal indicator lights, but also to a speaker and a microphone to provide greatly enhance functionality and safety. A logic control in the vehicle control unit is preferably designed to ensure that, in case there is a rider or passenger in addition to the vehicle operator, the turn and brake signals are transmitted to the rider's (passenger's) helmet and the audible or light signals to indicate that the turn signal is on are communicated to the operator of the vehicle.

The inclusion of a speaker and microphone permits two-way audio communications between the wearer of the helmet and others either through a cellular network or through a wireless connection to the helmet of a passenger of the vehicle, and further permits transmission of voice instructions to a navigation system and reception/playback of responsive navigation information, such as turn-by-turn directions, without requiring the operator of the vehicle to turn away from the road ahead. When combined with helmet-mounted brake and turn signal indicators, the helmet offers a system that greatly enhances operator safety without any added operational complexity.

By including a speaker in the helmet, it is possible to provide audible feedback when using the turn signal, similar to the clicking sound generated with the turn signal of an automobile is activated. Current motorcycle and bicycle turn signal devices lack this audible feedback, discouraging use.

Preferably, the communications are coded to prevent interference and also to provide, in combination with brake and/or turn signal indicators, an anti-theft indicator. To function as an anti-theft indicator, the helmet brake and turn signal indicators must be provided as standard equipment with the vehicle, such that helmet mounted signals are only activated if capable of receiving and decrypting brake and/or turn signals output by the vehicle, in which case an operator without functioning helmet-mounted brake and/or turn signals could be assumed by police to be an unauthorized user or thief.

Because the helmet is in digital communication with the transceiver on the vehicle, an interlock may be provided to prevent starting/operation of the vehicle unless the smart-key is in proximity to the vehicle, thereby providing further anti-theft protection. On the other hand, to prevent theft of the helmet in case it must be left with the vehicle, a physical smart-lock locking mechanism may also be provided to secure the helmet to the vehicle and prevent removal unless the smart-key is present.

Communications between transceivers on the vehicle and in the helmet may use radio frequency (RF) signals, Bluetooth, or any other wireless communications format or protocol.

### BRIEF DESCRIPTION OF THE DRAWINGS

FIG. 1 is a rear view of a helmet constructed in accordance with the principles of a preferred embodiment of the invention.

FIG. 2 is a front view of the helmet of FIG. 1.

FIG. 3 is a perspective view of a physical locking system for use with the helmet of FIGS. 1 and 2.

FIG. 4 is a perspective view of a battery charging arrangement for use with the helmet of FIGS. 1 and 2.

FIG. 5 is a schematic diagram of a vehicle-mounted control unit for use with the helmet of FIGS. 1 and 2.

FIG. 6 is a top view of a Bluetooth/wireless enabled smart key that may be used in connection with the control unit of FIG. 5.

### DETAILED DESCRIPTION OF THE PREFERRED EMBODIMENTS

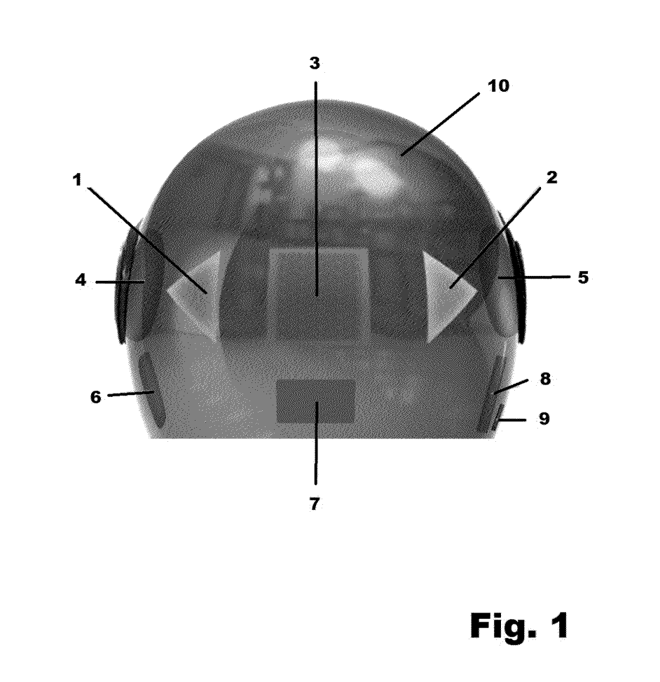

As illustrated in FIG. 1, the system of the invention includes a helmet 10 including a left turn indicator 1, a right turn indicator 2, and a brake indicator 3. Indicators 1-3 are preferably in the form of appropriately-shaped clusters of light emitting diodes (LEDs), although other types of light elements, such as electro-luminescent panels, may be used. If LEDs are used, the LEDs are preferably high flux type LEDs having suitable colors and arranged in arrays of suitable shape, such as arrow-shaped arrays of orange LEDs for the left and right turn indicators and a rectangular-shaped array of red LEDs for the brake indicator. The colors may be varied according to local traffic regulations, customs, or preferences, as may the shapes of the indicators.

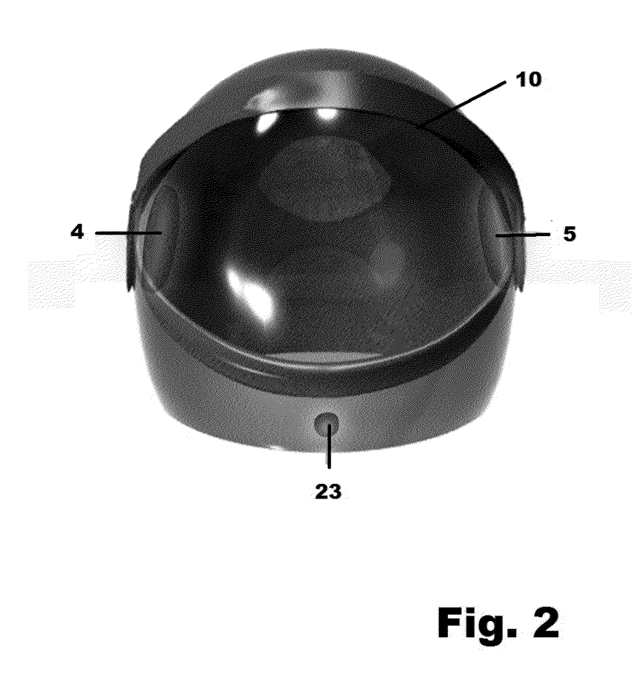

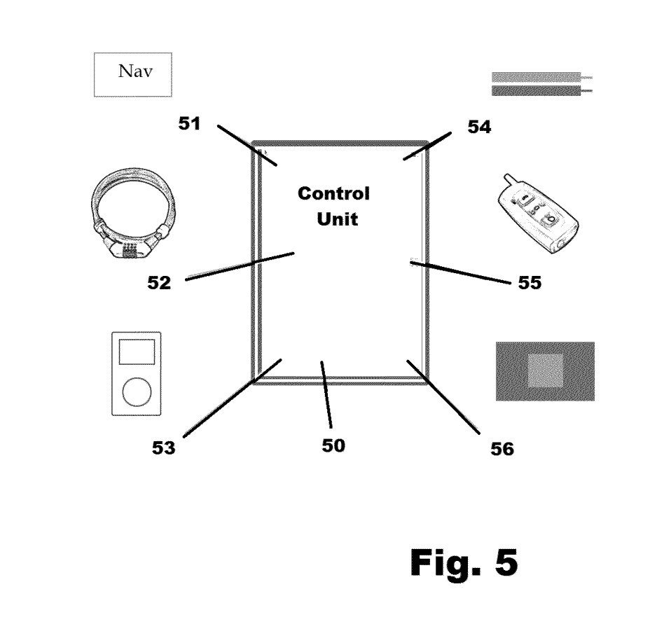

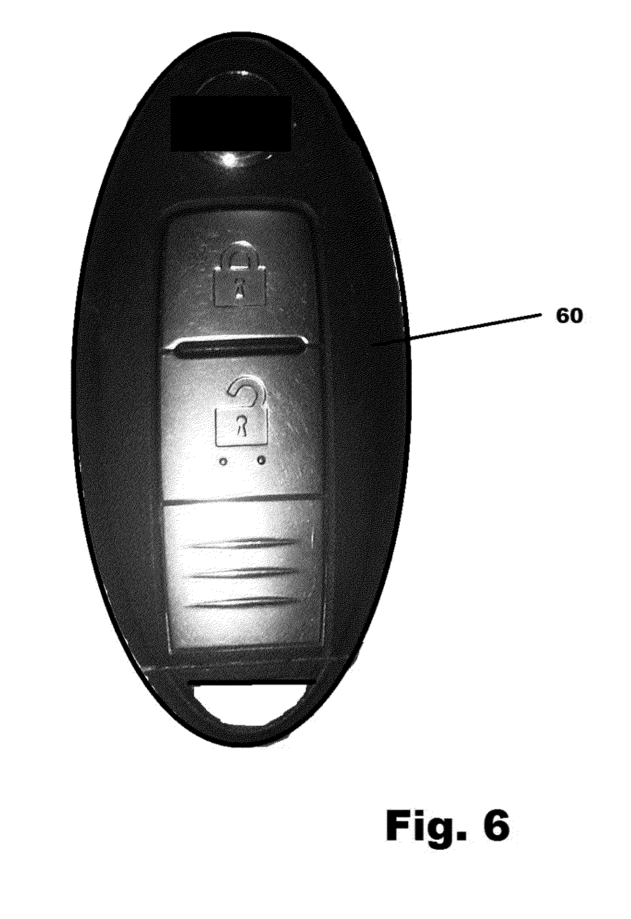

Also shown in FIG. 1, and also shown in FIG. 2, are an integrated left speaker 4 and an integrated right speaker 5, both of which are built-into the helmet, and integrated two-way communications unit 6 to enable bi-directional secure communications. The communications unit is preferably a digital transceiver, such as a Bluetooth unit or dongle, and is arranged to communicate with a corresponding transceiver or unit mounted on the vehicle, such as unit 55 one shown in FIG. 5. A helmet control unit 7 mounted on the helmet contains necessary logic control electronics to activate the helmet control unit when started by the smart key 60 shown in FIG. 6. The control unit is connected to a local power source, such as rechargeable battery unit 8. The battery unit may include one or more batteries, such as high capacity Lithium Ion batteries, and may also include an electrical socket 9 for connecting the battery unit to a recharging system, and/or some sort of local source of charging power such as a movement or vibration-responsive generator or solar cells.

FIG. 2 is a front view of the helmet 10 of FIG. 1, showing the left and right speakers 4 and 5, and also an integrated microphone 23. When the wireless communication unit 6 is in communication with a corresponding wireless communication unit 55, the speakers 4,5 and microphone 23 enable a wearer of the helmet to safely carry out voice communications while operating the vehicle, as well as providing a number of enhanced functions, as follows:

First, when connected to a cellular transceiver, either on the helmet or through the wireless communications unit 6 with the vehicle, inclusion of speakers 4,5 and microphone 23 enables the wearer of the helmet to carry out two-way cellular telephone conversations while operating the vehicle.

Second, if a rider of the vehicle is equipped with a similar helmet, the wireless communications link can be used to transmit communications between the operator of the vehicle and the rider. Currently, the operator of a motorcycle must communicate with a passenger seated to the rear of the operator by turning his head to enable the passenger to hear the operator over vehicle, road, and wind noise, creating a safety hazard. Also, it is difficult for a parent to communicate with a child in a bicycle car seat or trailer due to ambient noise and the sound muffling effect of the child's helmet. These problems of communication between the rider and operator are solved by two-way helmet-to-helmet voice communications, either directly between transceivers on the helmets, or via a transceiver on the vehicle such as transceiver 55 shown in FIG. 5.

Third, the speakers 4,5 can be used to play radio stations or recorded audio/music (at an appropriate volume to ensure safety) and/or to enable the operator to listen to vehicle or driving related information such as turn-by-turn navigation commands or instructions from a navigation and/or GPS system mounted on or integrated into the vehicle, hazard or traffic warnings, and so forth.

One particularly useful piece of vehicle information relates to operation of the turn signals, and involves playing a clicking or other noise to indicate that the turn signals have been activated, so that the operator will be reminded to deactivate the turn signal after a turn has been made and avoid confusion on the part of other vehicles as to the operator's intentions. This is a useful feature even if not tied to activation of a helmet-mounted turn-signal indicator since conventional motorcycle turn signals, which are activated by mechanical switches, do not return to a neutral position after a turn, and therefore must always be positively deactivated by the operator of the vehicle. Optionally, instead of providing a “clicking” sound feedback, or in addition to the audible feedback, additional LED lights could also be incorporated inside the helmet such that a left LED light inside the helmet will blink in conjunction with the left turn signal and a right LED light inside the helmet will blink in conjunction with the right turn signal.

The use of digital wireless communications enables the wireless signal to the helmet to be password protected and encrypted, thereby preventing the features of the helmet from being activated by an unauthorized user, and also limiting communications between the helmet and the vehicle to authorized operators. High end motorcycles such as BMW, Honda and Kawasaki's are often stolen and sold for parts before the police can track them down. If near-field secure communications technology is incorporated in the motorcycle then only a securely paired and password protected helmet will communicate with the motorcycle's inbuilt communications system. In other words, since the helmet of the preferred embodiments is digitally and wirelessly connected to the bike, only an authorized user with the correct digital and mechanical key can digitally pair the helmet with the bike. Thus, any helmet which does not light up when the rider brakes or indicates a turn signal could potentially signal a stolen vehicle to a police officer patrolling the streets. This increases the chances of recovering stolen vehicles before they are taken to a chop shop.

The digital pairing of helmet and vehicle is similar in concept to the current technology deployed in cars whereby an electronic key is used to start the car. An electronic smart key 60, as shown in FIG. 6 and described below, will simultaneously engage the electrical system of the vehicle control unit to disarm the alarm system, unlock the helmet if locked with a smart lock, activate the helmet control system, and pair the helmet control system to the vehicle control unit. Thus, based on the proximity of the electronic smart key 60 and by a single press of an “Unlock” button on the smart key, the authorized user is able to start his vehicle, either electrically or by kick-starting. If a thief is somehow able to fool the ignition and start the vehicle to steal it, then in no circumstances will he be able to pair the helmet digitally to the vehicle, and the turn and stop signals from the vehicle will not be transmitted to the helmet. A lack of turn and stop signals in the helmet, when the same light up on the vehicle, would indicate a very high probability of a stolen vehicle. In addition, the system of the preferred embodiment may also be modified to include vehicle tracking technology such as LoJack™ or GPS-based tracking services in case the vehicle is stolen.

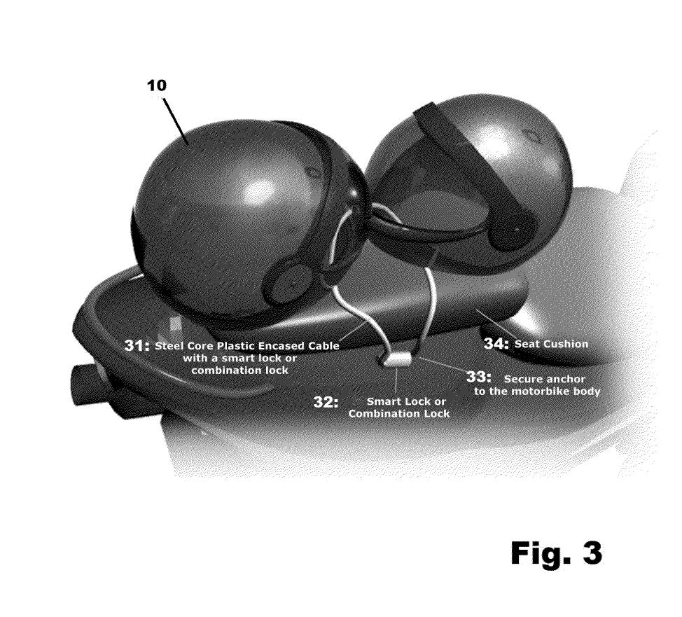

Turning to FIG. 3, the system also provides for physical locks to securely fasten the helmet to the motorbike seat when not in use. The helmet locking system is illustrated as including a cable 31 with a lock (also shown in FIG. 5), the cable being desired to be secured to the helmet 10 as well as to a secure anchor 33 on an appropriate part of the vehicle such as a metallic structural part of a motorbike body, which may be a support for the illustrated seat cushion 34. By way of example and not limitation, the cable may be a steel core plastic encased cable, such as are often used for bicycle or motorcycle locks, combined with a smart lock 32 that unlocks the cable only when in proximity to a smart key, although it is also possible to add or substitute a combination lock feature to enable manual unlocking. Two such helmets can be locked on the seat in this manner. This promotes enhanced safety since a lot of users fail to use helmets for lack of a place to put their helmet when they go to a meeting or social occasion. Imagine going to a dinner at a restaurant with a helmet in hand! Most commercial establishments are not equipped to handle many helmets without clutter. With the present invention, there is no fear of a helmet getting stolen since it is digitally locked to the bike and is also digitally paired to the bike.

Further, the cable locking system may be designed so as to hold the helmet or helmets on the seat cushion in the locked position so that a thief has no option but to ride the bike with the helmets on the cushion, or to physically cut the cable to remove the helmets. Since the cable is an integral part of the security system of the helmet and the bike, any tampering with the cable will set off the anti-theft provisions of the system and horns will start blaring and/or lights will start flashing—akin to an automotive alarm. In either case, the clear signs of theft are immediately visible and audible to all.

The smart lock could be magnetically activated such that when the smart key is within a defined proximity, the helmet can be unlocked with the press of a button so that the rider may unlock either one or both the helmets. The smart lock allows the operator to lock and unlock the helmet even in poor visibility such as in the night or when it is raining or snowing.

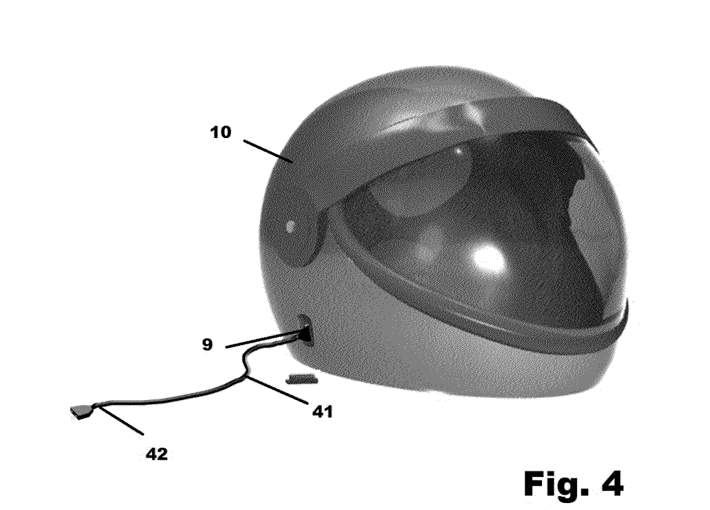

FIG. 4 shows a charging system for the battery unit 8 of the helmet, which is shown in FIG. 1. This charging system may include a transformer/charging circuit (not shown), and a cable 41 for connecting socket 9 of the battery unit 8 to an electrical outlet of a conventional 120V or 220V AC electrical system via plug 42.

FIG. 5 shows an example of the discrete control unit 50 for use with the helmet of FIGS. 1 and 2. Although illustrated as a discrete unit, it will be appreciated that any or all elements of the control unit 50 may be built-into or integrated with the vehicle itself, external devices connected to inputs of the control unit may be replaced by internal devices or circuits built-into the control unit, and that the number and nature of the inputs, as described below, may be varied to meet safety requirements and consumer or operator preference.

As illustrated, control unit 50 may include an input 51 from a navigation system and an input 53 from a portable music system such as an iPod or other MP3 player. These inputs may, alternatively be built-into the control unit 50 or replaced by a common input, such as a USB connector, from a multiple-function device such as a GPS-enable Bluetooth cell phone. Also included in the control unit 50 shown in FIG. 5 is an input 54 from the vehicle's electrical system, and a communications unit 55 which, like communications unit 6 on the helmet, may include a Bluetooth unit or other wireless transceiver that is preferably capable of digital communications. Still further, the control unit 50 may include an input 52 from the helmet locking cable, as well as any suitable controller or microprocessor 56 capable of providing signals to the communications unit or transceiver to carry out the above-described signaling and communications functions. It will be appreciated that navigation, signaling, and voice/audio functions are also found on automobiles, and that similar circuitry may be used for control unit 50.

Finally, to provide further security, the control unit 50 may be securely built into the bike in such a way that any forced removal will trigger the motorbikes horns and lights akin to a car safety alarm. In a factory manufactured environment, the control unit 50, or parts of the control unit 50 such as communications unit 55, could be securely built into the bike, for example inside and the bottom of the fuel tank, so that removal or tempering with it is virtually impossible without damaging the bike.

FIG. 6 shows an example of a smart key 60 that may be used in connection with the control unit 50 of FIG. 5. Smart key 6 is an integral part of the security system, and is preferably a proximity based smart key—the rider of the bike needs to have it on himself or herself—in a pocket, in a purse, etc. The smart key 6 disarms the motorbike control unit's anti-theft signals, simultaneously unlocks the rider's helmet, if it is locked with a smart lock, and simultaneously pairs the motorbike control unit with the helmet control unit through a randomly generated random number with challenge-response authentication system. The proximity can be set to a distance of anywhere from less than one feet to several feet.

Having thus described preferred embodiments of the invention in sufficient detail to enable those skilled in the art to make and use the invention, it will nevertheless be appreciated that numerous variations and modifications of the illustrated embodiment may be made without departing from the spirit of the invention, and it is intended that the invention not be limited by the above description or accompanying drawings, but that it be defined solely in accordance with the appended claims.

I claim:

1. A motorcycle or bicycle type helmet, comprising:
a helmet body;
turn and brake indicators on the helmet body;
at least one speaker on the helmet body;
at least one microphone on the helmet body;
a wireless transceiver on the helmet body, said transceiver on the helmet body being connected securely and wirelessly to a corresponding transceiver mounted on a motorcycle, bicycle, or other vehicle,
wherein the turn and brake indicators are activated by signals received via the transceiver on the helmet body, and wherein the speaker plays back and the microphone generates audio signals for transmission via the transceiver on the helmet body.

2. A helmet as claimed in claim 1, wherein the signals transmitted between the transceivers on the motorcycle, bicycle, or other vehicle and on the helmet body are digital wireless signals.

3. A helmet as claimed in claim 2, wherein the signals are Bluetooth signals.

4. A helmet as claimed in claim 1, wherein the signals transmitted between the transceivers on the motorcycle, bicycle, or other vehicle and on the helmet body are cellular telephone voice signals.

5. A helmet as claimed in claim 1, wherein the signals transmitted between the transceivers on the motorcycle, bicycle, or other vehicle and on the helmet body are audio turn-by-turn directions and navigation system voice commands.

6. A helmet as claimed in claim 1, wherein the signals transmitted between the transceivers on the motorcycle, bicycle, or other vehicle and on the helmet body are audio signals from an entertainment system.

7. A helmet as claimed in claim 1, wherein the signals transmitted between the transceivers on the motorcycle, bicycle, or other vehicle and on the helmet body are further transmitted to another helmet so that the operator of the motorcycle, bicycle, or other vehicle can communicate with a passenger.

8. A helmet as claimed in claim 1, further comprising a battery pack mounted on the helmet.

9. A helmet as claimed in claim 1, wherein the speakers and microphone are integrated into the helmet body.

10. A helmet as claimed in claim 1, further comprising a controller connected to the transceiver on the helmet, said controller being capable of encrypting and decrypting communications through the transceiver to thereby digitally pair the helmet with a particular vehicle such that signaling features of the helmet are inoperative unless a smart-key is in proximity to the vehicle.

11. A system for enhancing safety of a motorcycle, bicycle, or other vehicle for which an operator wears a helmet, comprising:
a helmet;
turn and brake indicators on the helmet;
at least one speaker on the helmet;
at least one microphone on the helmet;
a wireless transceiver on the helmet;
a wireless transceiver on the motorcycle, bicycle, or other vehicle, said transceiver on the helmet being connected to the turn and brake indicators and to the speaker and microphone to carry out wireless communications with the corresponding transceiver on the motorcycle, bicycle, or other vehicle,
wherein the turn and brake indicators are activated by signals received via the transceiver on the helmet body, and wherein the speaker plays back and the microphone generates audio signals for transmission via the transceiver on the helmet body.

12. A system as claimed in claim 11, wherein the signals transmitted between the transceivers on the motorcycle, bicycle, or other vehicle and on the helmet body are digital wireless signals.

13. A system as claimed in claim 12, wherein the signals are Bluetooth signals.

14. A system as claimed in claim 11, wherein the signals transmitted between the transceivers on the motorcycle, bicycle, or other vehicle and on the helmet body are cellular telephone voice signals.

15. A system as claimed in claim 11, wherein the signals transmitted between the transceivers on the motorcycle, bicycle, or other vehicle and on the helmet body are audio turn-by-turn directions and navigation system voice commands.

16. A system as claimed in claim 11, wherein the signals transmitted between the transceivers on the motorcycle, bicycle, or other vehicle and on the helmet body are audio signals from an entertainment system.

17. A system as claimed in claim 11, wherein the signals transmitted between the transceivers on the motorcycle, bicycle, or other vehicle and on the helmet body are further transmitted to another helmet so that the operator of the motorcycle, bicycle, or other vehicle can communicate with a passenger.

18. A system as claimed in claim 11, further comprising a battery pack mounted on the helmet.

19. A system as claimed in claim 11, wherein the speakers and microphone are integrated into the helmet body.

20. A system as claimed in claim 11, further comprising a controller connected to the transceiver on the helmet, said controller being capable of encrypting and decrypting communications through the transceiver to thereby digitally pair the helmet with a particular vehicle such that signaling features of the helmet are inoperative unless the helmet is in proximity to the vehicle.

21. A system as claimed in claim 11, further comprising a locking cable for securing the helmet to the motorcycle, bicycle, or other vehicle when the helmet is not being worn.
